(19) United States
(12) Patent Application Publication
(10) Pub. No.: US 2011/0216099 A1
(43) Pub. Date: Sep. 8, 2011

(54) DRIVING METHOD OF ELECTROPHORETIC DISPLAY DEVICE, AND CONTROLLER

(75) Inventor: Yusuke YAMADA, Shiojiri (JP)

(73) Assignee: SEIKO EPSON CORPORATION, Tokyo (JP)

(21) Appl. No.: 13/028,445

(22) Filed: Feb. 16, 2011

(30) Foreign Application Priority Data
Mar. 3, 2010 (JP) 2010-046904

(51) Int. Cl. G09G 3/34; G09G 5/10

(52) U.S. Cl. 345/690; 345/107

(57) ABSTRACT

A driving method of an electrophoretic display device, which has a plurality of pixels where an electrophoretic layer is interposed between a first electrode and a second electrode, including supplying a first voltage pulse with one polarity of the first polarity and the second polarity to the first pixel in a first display state; supplying a second voltage pulse with the other polarity of the first polarity and the second polarity to the first pixel; supplying a third voltage pulse, which has the same polarity as the polarity of the first voltage pulse and has a duration different from a duration of the first voltage pulse, to a second pixel which is in the first display state; and supplying the second voltage pulse to the second pixel.

### BACKGROUND

1. Technical Field

The present invention relates to a driving method of an electrophoretic display device.

2. Related Art

In this type of electrophoretic display device, in regard to each of a plurality of pixels, an image is displayed by moving the electrophoretic particles through application of a driving voltage to, for example, an electrophoretic layer including white and black electrophoretic particles interposed between a pixel electrode and a common electrode. Additionally, it is possible to perform multitone display where a halftone (for example, gray) is displayed by changing the period of time when a driving voltage is applied to the electrophoretic layer for each pixel. In order to perform multitone display with high precision, it is necessary to control the application time of a driving voltage with high precision.

For example, in JP-A-2007-79170, a technology is disclosed for preventing an uneven display of color in a case of switching between display colors in an electrophoretic display device, by changing the application time of a driving voltage in accordance with the continuous display time of a display color displayed before switching.

In this type of electrophoretic display device, there is a technical problem in that it is difficult to perform multitone display with high precision which requires controlling of the application time of the driving voltage with high precision. In particular, it is difficult to control the application time of the driving voltage so that the halftone to be displayed is accurately displayed in each pixel since the motion of the electrophoretic particles when applying the driving voltage varies with the environment, such as temperature and humidity. As a result, an accurate display is difficult when the number of gradation levels is increased.

### SUMMARY

An advantage of some aspects of the invention is that a driving method of an electrophoretic display device is provided which is capable of performing multitone display with high precision.

According to an aspect of the invention, there is provided a driving method of an electrophoretic display device, which has a plurality of pixels where an electrophoretic layer is interposed between a first electrode and a second electrode, and when in a case when the potential of the first electrode is higher than the potential of the second electrode, a potential difference generated between the first electrode and the second electrode is set to a first polarity, and in a case when the potential of the first electrode is lower than the potential of the second electrode, a potential difference generated between the first electrode and the second electrode is set to a second polarity, as a display state of the pixel, a first display state is selected by supplying a voltage with the first polarity to the pixel and a second display state is selected by supplying a voltage with the second polarity to the pixel, and in regard to one pixel with one display state of the first display state and the second display state, a halftone state between the first display state and the second display state is selected in accordance with a total duration of the voltage applied to select the other display state of the first display state and the second display state, including supplying a first voltage pulse with one polarity of the first polarity and the second polarity to a first pixel in the first display state of the plurality of pixels, supplying a second voltage pulse with the other polarity of the first polarity and the second polarity to the first pixel, supplying a third voltage pulse, which has the same polarity as the polarity of the first voltage pulse and has a duration different from the duration of the first voltage pulse, to a second pixel which is in the first display state of the plurality of pixels, and supplying the second voltage pulse to the second pixel.

According to the driving method of the invention, the first voltage pulse and the second voltage pulse with a polarity different from the first voltage pulse are supplied in sequence to the first pixel in the first display state (for example, white). According to this, the first pixel is in a halftone state. That is, in the first pixel, a first halftone which is, for example, a gray with a first density is displayed. In addition, the second voltage pulse typically has a duration different from the duration of the first voltage pulse, but it may have the same duration. Furthermore, according to the driving method of the invention, the second pixel which is in the first display state (for example, white) similar to the first pixel is supplied with the third voltage pulse, which has the same polarity as the first voltage pulse and has a duration different from a duration of the first voltage pulse, and is further supplied with the second voltage pulse similar to the first pixel. According to this, in the second pixel, a second halftone, which is, for example, a gray with a second density which is different from the first density, is displayed.

In this manner, in the invention, when displaying halftones which are different in the first pixel and the second pixel, the first voltage pulse is supplied to the first pixel in the first display state, the third voltage pulse (that is, the voltage pulse which has the same polarity as the first voltage pulse and has a duration different from the first voltage pulse) is supplied to the second pixel in the first display state, and the second voltage pulse (that is, the voltage pulse with a polarity different from the first voltage pulse and the third voltage pulse) is further applied to each of the first pixel and the second pixel.

Here, in a case where the first voltage pulse and the third voltage pulse have the first polarity, the first voltage pulse with the first polarity is supplied to the first pixel in the first display state and the third voltage pulse with the first polarity is supplied to the second pixel in the first display state. At this time, there is very little change or no change in the display state of the first pixel and the display state of the second pixel. However, in the electrophoretic particles included in the electrophoretic layer, Coulomb force acts for a longer time than in a case when neither the first voltage pulse nor the third voltage pulse is supplied.

On the other hand, in a case when the first voltage pulse and the third voltage pulse have the second polarity, by supplying the first voltage pulse which has the second polarity to the first pixel in the first display state, the first pixel is in a halftone state between the first display state and the second display state. Additionally, by supplying the third voltage pulse which has the second polarity to the second pixel in the first display state, the second pixel is in a halftone state different from the first pixel.

In the invention, in particular, the first pixel and the second pixel supplied with the first voltage pulse and the third voltage pulse in this manner are supplied with the second voltage pulse with a polarity different from the first voltage pulse and the third voltage pulse. According to this, it is possible to reduce a difference in the display state of the first pixel and the display state of the second pixel. In other words, it is possible to finely control the difference in gradation between the first pixel and the second pixel. That is, for example, it is possible to express a finer gradation using the first pixel and the second pixel compared to a case where the gradation displayed using the first pixel and the gradation displayed using the second pixel are controlled by supplying only the first voltage pulse to the first pixel in the first display state and supplying only the third voltage pulse to the second pixel in the first display state. Accordingly, the number of gradations which can be displayed increases and it is possible to perform multitone display with high precision.

In addition, the effects of the invention have been experimentally confirmed by the inventors.

As described above, according to the driving method of the electrophoretic display device of the invention, it is possible to perform multitone display with high precision.

In an aspect of the driving method of the electrophoretic display device of the invention, there is included supplying a fourth voltage pulse with one polarity of the first polarity and the second polarity to a third pixel in the second display state of the plurality of pixels, supplying a fifth voltage pulse with the other polarity of the first polarity and the second polarity to the third pixel, supplying a sixth voltage pulse, which has the same polarity as the polarity of the fourth voltage pulse and has a duration different from a duration of the fourth voltage pulse, to a fourth pixel which is in the second display state of the plurality of pixels, and supplying the fifth voltage pulse to the fourth pixel.

According to the aspect, when displaying halftones which are different in the third pixel and the fourth pixel, the fourth voltage pulse is supplied to the third pixel in the second display state, the sixth voltage pulse (that is, the voltage pulse which has the same polarity as the fourth voltage pulse and has a duration different from the fourth voltage pulse) is supplied to the fourth pixel in the second display state, and the fifth voltage pulse (that is, the voltage pulse with a polarity different from the fourth voltage pulse and the sixth voltage pulse) is further applied to each of the third pixel and the fourth pixel.

Here, in a case where the fourth voltage pulse and the sixth voltage pulse have the second polarity, the fourth voltage pulse with the second polarity is supplied to the third pixel in the second display state and the sixth voltage pulse with the second polarity is supplied to the fourth pixel in the second display state. At this time, there is very little change or no change in the display state of the third pixel and the display state of the fourth pixel. However, in the electrophoretic particles included in the electrophoretic layer, Coulomb force acts for a longer time than in a case when neither the fourth voltage pulse nor the sixth voltage pulse is supplied.

On the other hand, in a case when the fourth voltage pulse and the sixth voltage pulse have the first polarity, by supplying the fourth voltage pulse which has the first polarity to the third pixel in the second display state, the third pixel is in a halftone state between the first display state and the second display state. Additionally, by supplying the sixth voltage pulse which has the first polarity to the fourth pixel in the second display state, the fourth pixel is in a halftone state different from the third pixel.

In the aspect, in particular, the third pixel and the fourth pixel supplied with the fourth voltage pulse and the sixth voltage pulse in this manner are supplied with the fifth voltage pulse with a polarity different from the fourth voltage pulse and the sixth voltage pulse. According to this, it is possible to reduce the difference in the display state of the third pixel and the display state of the fourth pixel. In other words, it is possible to finely control the difference in gradation between the third pixel and the fourth pixel. That is, in the third pixel and fourth pixel, the number of gradations of gradations which can be displayed increases and it is possible to perform multitone display with high precision.

In another aspect of the driving method of the electrophoretic display device of the invention, supplying a seventh voltage pulse with a polarity different from the second voltage pulse to the first pixel and the second pixel is further included.

According to the aspect, for example, after the second voltage pulse is supplied to the first pixel and the second pixel, the seventh voltage pulse with a polarity different from the second voltage pulse is supplied to the first pixel and the second pixel. According to this, it is possible to further accurately display each of the display state of the first pixel (for example, a halftone state) and the display state of the second pixel. Accordingly, it is possible to further finely control the difference in a gradation displayed using the first pixel and a gradation displayed using the second pixel.

In another aspect of the driving method of the electrophoretic display device of the invention, there is included supplying an eighth voltage pulse with a polarity different from the fifth voltage pulse to the third pixel and the fourth pixel.

According to the aspect, for example, after the fifth voltage pulse is supplied to the third pixel and the fourth pixel, the eighth voltage pulse with a polarity different from the fifth voltage pulse is supplied to the third pixel and the fourth pixel. According to this, it is possible to further accurately display each of the display state of the third pixel (for example, a halftone state) and the display state of the fourth pixel. Accordingly, it is possible to further finely control a difference in a gradation displayed in the third pixel and a gradation displayed in the fourth pixel.

The actions and other advantages of the invention will be made clear from the embodiment for executing the invention described next.

### BRIEF DESCRIPTION OF THE DRAWINGS

The invention will be described with reference to the accompanying drawings, wherein like numbers reference like elements.

FIG. 1 is a block diagram illustrating an overall configuration of an electrophoretic display device according to a first embodiment.

FIG. 2 is an equivalent circuit diagram illustrating an electrical configuration of a pixel of the electrophoretic display device according to the first embodiment.

FIG. 3 is a partial cross-sectional diagram of a display unit of the electrophoretic display device according to the first embodiment.

FIG. 4 is a schematic diagram illustrating a configuration of a microcapsule.

FIG. 5 is a schematic diagram illustrating the display unit of the electrophoretic display device in a state where an example of an image including a plurality of halftones is displayed.

FIG. 6 is a flow chart illustrating a driving method of the electrophoretic display device according to the first embodiment.

FIGS. 7A to 7D are schematic diagrams (1) illustrating display states of pixels when each step shown in FIG. 6 is performed.

FIGS. 8A to 8D are schematic diagrams (2) illustrating display states of pixels when each step shown in FIG. 6 is performed.

FIGS. 9A to 9D are schematic diagrams (3) illustrating display states of pixels when each step shown in FIG. 6 is performed.

FIG. 10 is a conceptual diagram (1) for describing the driving method of the electrophoretic display device according to the first embodiment.

FIG. 11 is a conceptual diagram (2) for describing the driving method of the electrophoretic display device according to the first embodiment.

### DESCRIPTION OF EXEMPLARY EMBODIMENTS

Below, the embodiments of the invention are described while referring to the diagrams.

### First Embodiment

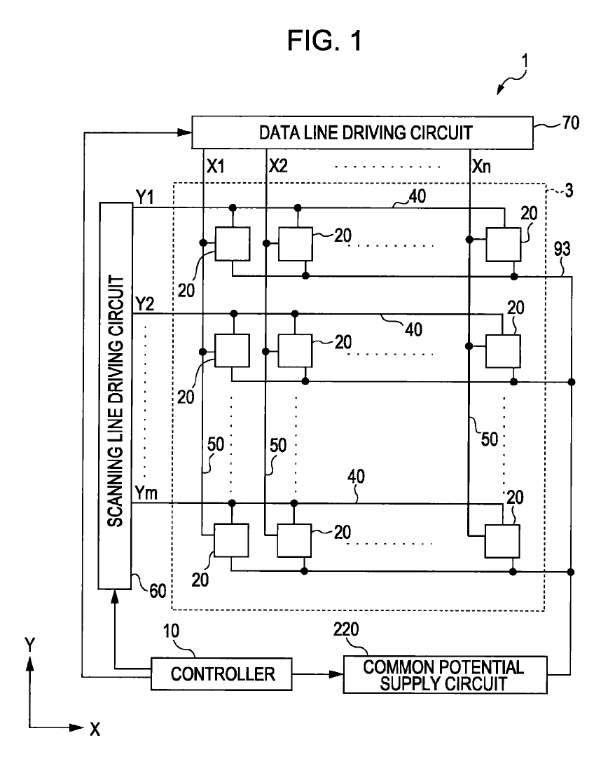

A driving method of an electrophoretic display device according to the first embodiment will be described with reference to FIGS. 1 to 11.

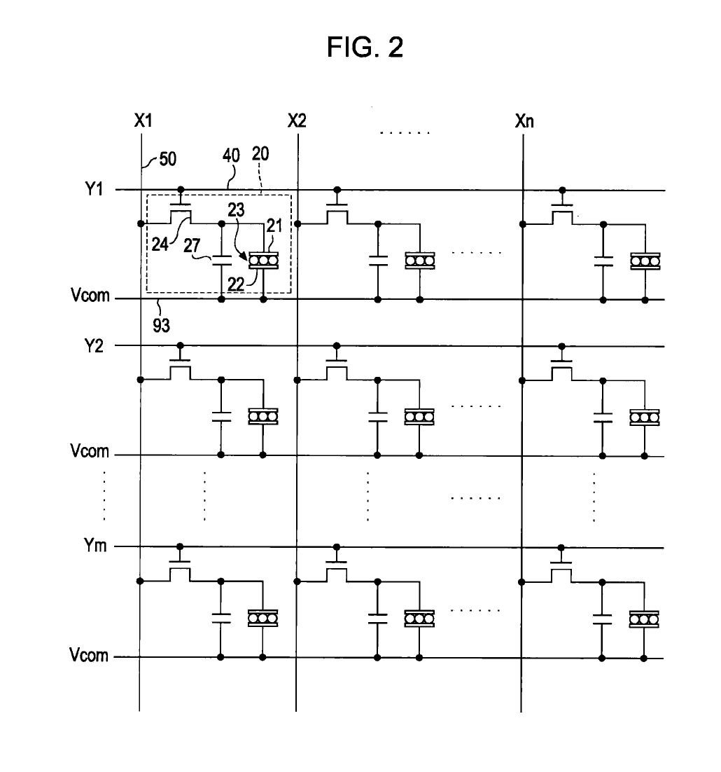

First, an overall configuration of the electrophoretic display device according to the embodiment will be described with reference to FIGS. 1 and 2.

FIG. 1 is a block diagram illustrating the overall configuration of the electrophoretic display device according to the embodiment.

In FIG. 1, an electrophoretic display device 1 according to the embodiment includes a display unit 3, a controller 10, a scanning line driving circuit 60, a data line driving circuit 70 and a common potential supply circuit 220.

In the display unit 3, m rows and n columns of pixels 20 are arranged in a matrix (two dimensional planar) shape. Also, in the display unit 3, m scanning lines 40 (that is, scanning lines Y1, Y2, . . . , Ym) and n data lines 50 (that is, data lines X1, X2, . . . , Xn) are provided to intersect with each other. Specifically, the m scanning lines 40 extend in a row direction (that is, an X direction) and the n data lines 50 extend in a column direction (that is, a Y direction). The pixels 20 are arranged to correspond to the intersections of the m scanning lines 40 and the n data lines 50.

The controller 10 controls the operations of the scanning line driving circuit 60, the data line driving circuit 70, and the common potential supply circuit 220. The controller 10 supplies timing signals such as clock signals and start pulses to each circuit.

The scanning line driving circuit 60 supplies scanning signals to each of the scanning lines Y1, Y2, . . . , Ym based on timing signals supplied from the controller 10.

The data line driving circuit 70 supplies data signals to the data lines X1, X2, . . . , Xn based on timing signals supplied from the controller 10. The data signals take on potentials with 2 values, a high potential VH (for example, 15V) or a low potential VL (for example, 0V).

The common potential supply circuit 220 supplies a common potential Vcom to a common potential line 93.

In addition, various types of signals are input and output in the controller 10, the scanning line driving circuit 60, the data line driving circuit 70, and the common potential supply circuit 220. However, descriptions of signals which have no particular relevance to the embodiment are not included.

FIG. 2 is an equivalent circuit diagram illustrating an electrical configuration of a pixel.

In FIG. 2, the pixel 20 includes a pixel circuit (namely, a 1T1C type pixel circuit) which has a pixel switching transistor 24 and a condenser (retention capacity) 27, a pixel electrode 21, a common electrode 22 and an electrophoretic layer 23.

The pixel switching transistor 24 is configured as, for example, an N type transistor. The gate of the pixel switching transistor 24 is electrically connected to the scanning line 40, the source of the pixel switching transistor 24 is electrically connected to the data line 50, and the drain of the pixel switching transistor 24 is electrically connected to the pixel electrode 21 and the condenser 27. The pixel switching transistor 24 outputs the data signals supplied from the data line driving circuit 70 (refer to FIG. 1) via the data line 50 to the pixel electrode 21 and the condenser 27 at a timing corresponding to the scanning signals supplied from the scanning lines driving circuit 60 (refer to FIG. 1) via the scanning line 40.

In the pixel electrode 21, the data signals are supplied from the data line driving circuit 70 via the data line 50 and the pixel switching transistor 24. The pixel electrode 21 is arranged to face the common electrode 22 through the electrophoretic layer 23.

The common electrode 22 is electrically connected to the common potential line 93 which is supplied with the common potential Vcom.

The electrophoretic layer 23 includes a plurality of microcapsules which each include electrophoretic particles.

The condenser 27 is formed from a pair of electrodes arranged to face each other through a dielectric film. One of the electrodes is electrically connected to the pixel electrode 21 and the pixel switching transistor 24, and the other electrode is electrically connected to the common potential line 93. It is possible to hold the data signals only for a predetermined period of time using the condenser 27.

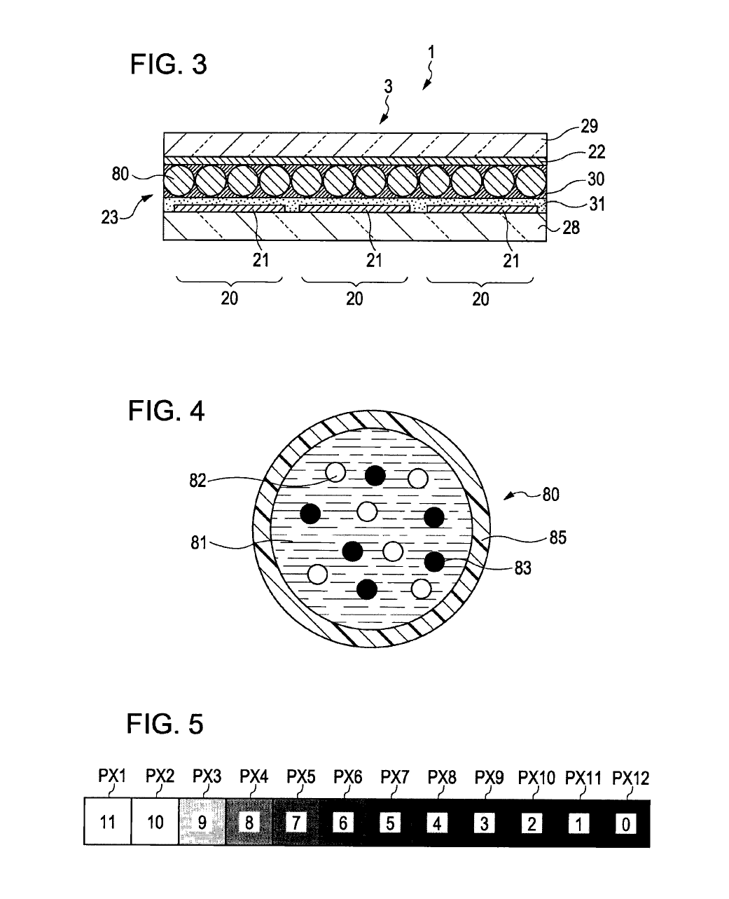

Next, a specific configuration of a display unit of the electrophoretic display device according to the embodiment is described with reference to FIGS. 3 and 4.

FIG. 3 is a partial cross-sectional diagram of the display unit of the electrophoretic display device according to the embodiment.

In FIG. 3, the display unit 3 has the configuration where the electrophoretic layer 23 is interposed between an element substrate 28 and an opposing substrate 29. In addition, in the embodiment, the description is made assuming that an image is displayed on the opposing substrate 29 side.

The element substrate 28 is a substrate formed from, for example, glass, plastic or the like. Although not shown diagrammatically here, on the element substrate 28, a laminate structure is formed with the pixel switching transistor 24, the condenser 27, the scanning line 40, the data line 50, the common potential line 93 and the like described above with reference to FIG. 2. A plurality of the pixel electrodes 21 are provided in a matrix shape on the upper layer side of the laminate structure.

The opposing substrate 29 is a transparent substrate formed from, for example, glass, plastic or the like. On a surface of the opposing substrate 29 which faces the element substrate 28, the common electrode 22 is provided to face the plurality of pixel electrodes 21. The common electrode 22 is formed from a transparent and conductive material such as, for example, magnesium-silver (MgAg), indium tin oxide (ITO), and indium zinc oxide (IZO).

The electrophoretic layer 23 includes a plurality of microcapsules 80 which each include electrophoretic particles and is fixed between the element substrate 28 and the opposing substrate 29 by a binder 30 and an adhesive layer 31 formed from, for example, resin or the like. In addition, the electrophoretic display device 1 according to the embodiment is configured in a manufacturing process by an electrophoretic sheet, which is formed from the electrophoretic layer 23 being fixed in advance to the opposing substrate 29 side by the binder 30, being attached to the element substrate 28 side where the pixel electrode 21 and the like, which are manufactured separately, are bonded by the adhesive layer 31.

The microcapsules 80 are interposed between the pixel electrode 21 and the common electrode 22, and one or a plurality are arranged in one pixel 20 (in other words, in relation to one pixel electrode 21).

FIG. 4 is a schematic diagram illustrating a configuration of a microcapsule. In addition, in FIG. 4, a cross-section of the microcapsule is schematically shown.

In FIG. 4, the microcapsules 80 have enclosed a dispersion medium 81 inside of a capsule 85, a plurality of white particles 82 and a plurality of black particles 83. The microcapsules 80 are formed in a spherical shape with a particle diameter of, for example, approximately 50 μm.

The capsule 85 functions as the outer shell of the microcapsule 80 and is formed from a transparent polymer resin such as an acrylic resin such as polymethyl methacrylate or polyethyl ethacrylate, urea resin, gum Arabic or gelatin.

The dispersion medium 81 is a medium dispersing the white particles 82 and the black particles 83 in the microcapsules 80 (in other words, in the capsule 85). As the dispersion medium 81, water, alcohol based solvents such as methanol, ethanol, isopropanol, butanol, octanol, or methyl cellosolve, various types of esters such as ethyl acetate or butyl acetate, ketones such as acetone, methyl ethyl ketone or methyl isobutyl ketone, aliphatic hydrocarbons such as pentane, hexane, or octane, alicyclic hydrocarbons such as cyclohexane or methylcyclohexane, aromatic hydrocarbons such as benzene, toluene, xylene or benzenes with a long-chain alkyl group such as hexyl benzene, heptyl benzene, octyl benzene, nonyl benzene, decyl benzene, undecyl benzene, dodecyl benzene, tridecyl benzene or tetradecyl benzene, halogenated hydrocarbons such as methylene chloride, chloroform, carbon tetrachloride or 1,2-dichloroethane, carboxylate or other oils, can be used singularly or in combination. Also, in the dispersion medium 81, a surfactant may be included.

The white particles 82 are particles (polymer or colloid) formed from a white pigment such as titanium dioxide, Chinese white (zinc oxide) or antimony trioxide, and for example, are negatively charged.

The black particles 83 are particles (polymer or colloid) formed from a black pigment such as aniline black or carbon black, and for example, are positively charged.

As a result, the white particles 82 and the black particles 83 can be moved within the dispersion medium 81 using an electrical field generated by a difference in potential between the pixel electrode 21 and the common electrode 22.

In these pigments, electrolytes, surfactants, metallic soaps, resins, rubber, oils, varnishes, charge control agents formed from particles such as compounds, dispersants such as titanium-based coupling agents, aluminum-based coupling agents and silane-based coupling agents, lubricants, stabilizers and the like can be added as required.

In the FIGS. 3 and 4, in a case when a voltage is applied between the pixel electrode 21 and the common electrode 22 so that the potential of the common electrode 22 becomes relatively higher, the black particles 83 which are positively charged are drawn toward the pixel electrode 21 side in the microcapsule 80 due to Coulomb force and the white particles 82 which are negatively charged are drawn toward the common electrode 22 side in the microcapsule 80 due to Coulomb force. As a result, due to the white particles 82 collecting at the display surface side in the microcapsule 80 (that is, the common electrode 22 side), it is possible to display the color of the white particles 82 (that is, white) on the display surface of the display unit 3. Conversely, in a case when a voltage is applied between the pixel electrode 21 and the common electrode 22 so that the potential of the pixel electrode 21 becomes relatively higher, the white particles 82 which are negatively charged are drawn toward the pixel electrode 21 side due to Coulomb force and the black particles 83 which are positively charged are drawn toward the common electrode 22 side due to Coulomb force. As a result, due to the black particles 83 collecting at the display surface side in the microcapsule 80, it is possible to display the color of the black particles 83 (that is, black) on the display surface of the display unit 3.

In addition, below, in the case when the potential of the common electrode 22 is higher than the potential of the pixel electrode 21, the difference in potential (that is, voltage) generated between the common electrode 22 and the pixel electrode 21 is appropriately referred to as a “positive polarity voltage”, and in the case when the potential of the common electrode 22 is lower than the potential of the pixel electrode 21, the difference in potential generated between the common electrode 22 and the pixel electrode 21 is appropriately referred to as a “negative polarity voltage”. In addition, the common electrode 22 is an example of the “first electrode” according to the invention, and the pixel electrode 21 is an example of the “second electrode” according to the invention. Furthermore, positive polarity is an example of the “first polarity” according to the invention, and negative polarity is an example of the “second polarity” according to the invention.

That is, it is possible to display white in the pixel 20 by applying a positive polarity voltage to the pixel 20, and it is possible to display black in the pixel 20 by applying a negative polarity voltage to the pixel 20. In addition, a state where the pixel 20 displays white is an example of the “first display state” according to the invention and a state where the pixel 20 displays black is an example of the “second display state” according to the invention.

In addition, the common electrode 22 may be set as the “second electrode” according to the invention, and the pixel electrode 21 may be set as the “first electrode” according to the invention.

Furthermore, it is possible to display grays, such as light gray, gray and dark gray, which are halftones (that is, intermediate gradation) between white and black due to the dispersion state of the white particles 82 and the black particles 83 between the pixel electrodes 21 and the common electrodes 22. For example, after the white particles 82 collect at the display surface side of the microcapsule 80 and the black particles 83 collect at the pixel electrode 21 side due to a voltage applied between the pixel electrode 21 and the common electrode 22 so that the potential of the common electrode 22 becomes relatively higher (that is, by applying a positive polarity voltage), the black particles 83 are moved by only a predetermined amount to the display surface side of the microcapsule 80 and the white particles 82 are moved by a predetermined amount only to the pixel electrode 21 side due to a voltage applied between the pixel electrode 21 and the common electrode 22 so that the potential of the pixel electrode 21 becomes relatively higher (that is, by applying a negative polarity voltage) for only a predetermined period of time corresponding to halftone to be displayed. As a result, it is possible to display gray which is a halftone between white and black on the display surface of the display unit 3.

In addition, it is possible to display red, green, blue and the like by changing the pigments used in the white particles 82 and the black particles 83 with, for example, pigments which are red, green, blue or the like.

Next, a driving method of the electrophoretic display device according to the embodiment will be described with reference to FIGS. 5 to 11.

Below, a case, where an image including a plurality of halftones as shown in FIG. 5 is displayed on the display unit 3, is taken as an example. Here, FIG. 5 is a schematic diagram illustrating the display unit of the electrophoretic display device in a state where an example of an image including a plurality of halftones is displayed. An image including a plurality of halftones shown in FIG. 5 is an image with 12 gradations, and the 0^{th} gradation corresponds to black, the 1^{st} gradation to the 10^{th} gradation correspond to grays which each have different densities, and the 11^{th} gradation corresponds to white. Additionally, for the sake of description, in the display unit 3, 12 pixels 20 (that is, pixels PX1, PX2, . . . , PX12) are arranged.

That is, as shown in FIG. 5, a case, where the pixel PX1 displays the 11^{th} gradation, the pixel PX2 displays the 10^{th} gradation, the pixel PX3 displays the 9^{th} gradation, the pixel PX4 displays the 8^{th} gradation, the pixel PX5 displays the 7^{th} gradation, the pixel PX6 displays the 6^{th} gradation, the pixel PX7 displays the 5^{th} gradation, the pixel PX8 displays the 4^{th} gradation, the pixel PX9 displays the 3^{rd} gradation, the pixel PX10 displays the 2^{nd} gradation, the pixel PX11 displays the 1^{st} gradation, and the pixel PX12 displays the 0^{th} gradation, is taken as an example.

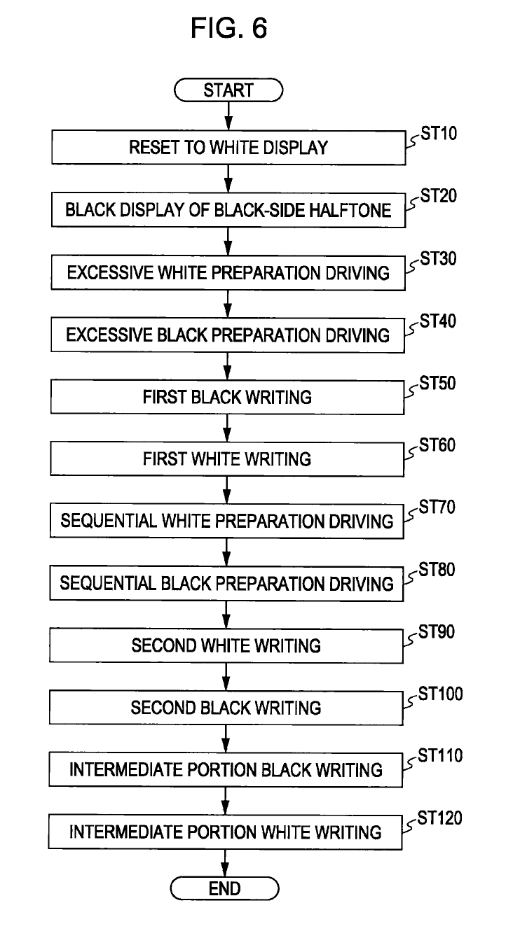

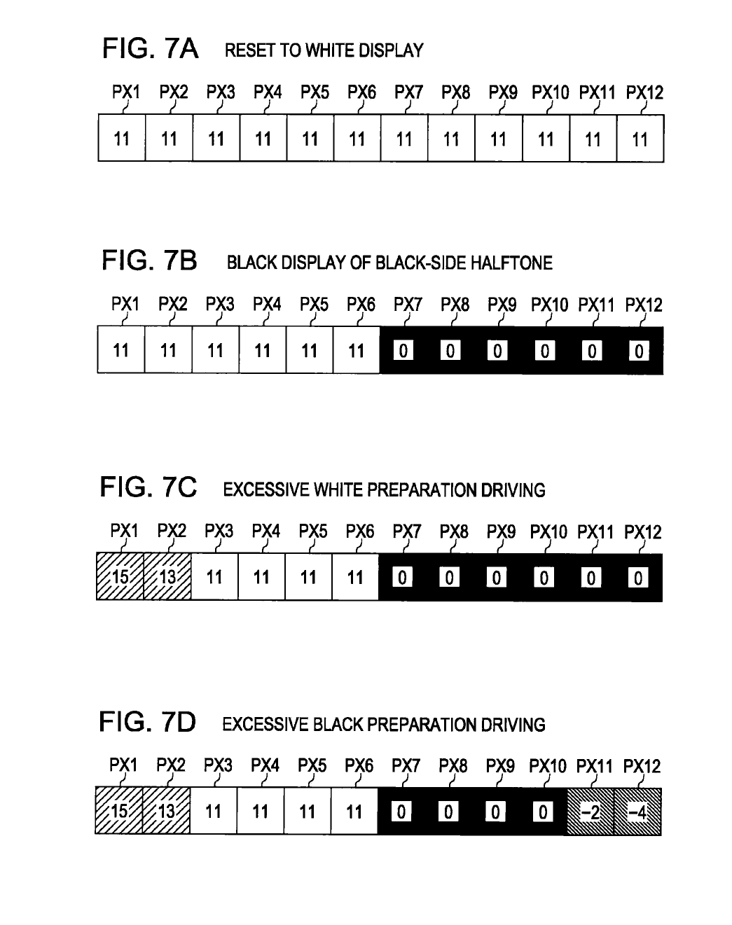

FIG. 6 is a flow chart illustrating the driving method of the electrophoretic display device according to the embodiment, and FIGS. 7A to 9D are schematic diagrams illustrating display states of pixels PX1 to PX12 when each step shown in FIG. 6 is performed.

In FIG. 6, according to the driving method of the electrophoretic display device according to the embodiment, when displaying an image including halftone as show in FIG. 5 for example, first, a reset to white display is performed (step ST10). That is, as shown in FIG. 7A, all of the pixels 20 display white (that is, the 11^{th} gradation) due to a positive polarity voltage being applied to all of the pixels 20 in the display unit 3. More specifically, in each of the pixels 20, data signals from the data line 50 via the pixel switching transistor 24 accumulate in the condenser 27, a voltage with the low potential VL is supplied to the pixel electrode 21 only for a predetermined period of time, and the common potential Vcom with the high potential VH is supplied to the common electrode 22 from the common potential supply circuit 220.

Next, in FIG. 6, black-side halftone pixels display black (step ST20). Here, the plurality of pixels 20 in the display unit 3 are divided into a first group of pixels, which display any of the 0^{th} gradation to the 5^{th} gradation which are close to black (that is, the 0^{th} gradation), and a second group of pixels, which display any of the 6^{th} gradation to the 11^{th} gradation which are close to white (that is, the 11^{th} gradation), out of the 12 gradation levels shown in FIG. 5. In the example shown in FIG. 5, the pixels PX7 to PX 12 belong to the first group. Then, as shown in FIG. 7B, the pixels PX7 to PX 12 belonging to the first group display black (that is, the 0^{th} gradation). More specifically, in each of the pixels PX7 to PX 12, data signals from the data line 50 via the pixel switching transistor 24 accumulate in the condenser 27, a voltage with the high potential VH is supplied to the pixel electrode 21 only for a predetermined period of time, and the common potential Vcom with the low potential VL is supplied to the common electrode 22 from the common potential supply circuit 220.

Next, in FIG. 6, excessive white preparation driving is performed (step ST30). That is, by supplying positive polarity voltage pulses to the pixels 20 which are to display the 11^{th} gradation and the pixels 20 which are to display the 10^{th} gradation out of the plurality of pixels 20 in the display unit 3, Coulomb force toward the common electrode 22 side (that is, display surface side) is added to the white particles 82 and Coulomb force toward the pixel electrode 21 side is added to the black particles 83. In the example in FIG. 5, out of the plurality of pixels 20 in the display unit 3, the pixel PX1 which is to display the 11^{th} gradation is supplied with a positive polarity voltage pulse P1 (refer to FIG. 10 described later), and the pixel PX2 which is to display the 10^{th} gradation is supplied with a positive polarity voltage pulse P2 (refer to FIG. 10 described later). In addition, the pixel PX1 is an example of the “first pixel” according to the invention, and the pixel PX2 is an example of the “second pixel” according to the invention. The voltage pulse P1 is an example of the “first voltage pulse” according to the invention, and the voltage pulse P2 is an example of the “third voltage pulse” according to the invention.

As such, in the pixel PX1 and pixel PX2, there is a state where Coulomb force toward the common electrode 22 side is added to the white particles 82 for a longer period of time and Coulomb force toward the pixel electrode 21 side is added to the black particles 83 for a longer period of time compared to pixel PX3 to pixel PX6. In other words, in the pixel PX1 and pixel PX2, there is a state where the white particles 82 are largely biased toward the common electrode 22 side and the black particles 83 are largely biased toward the pixel electrode 21 side compared to pixel PX3 to pixel PX6.

Normally, since the 11^{th} gradation is the whitest display state, the display state of the pixel PX1 and the display state of the pixel PX2 are difficult to distinguish from the display state of the pixel PX3 to the display state of the pixel PX6. However, in the description below, for convenience, as shown in FIG. 7C, each of the display state of the pixel PX1 and the display state of the pixel PX2 are appropriately described as a theoretical gradation higher than the 11^{th} gradation corresponding to a duration of the positive polarity voltage pulse applied in excessive white preparation driving (step ST30).

In the embodiment, a duration T1 of the positive polarity voltage pulse P1 supplied to the pixel PX1 which is to display the 11^{th} gradation is longer than a duration T2 of the positive polarity voltage pulse P2 supplied to the pixel PX2 which is to display the 10^{th} gradation. As such, for convenience, as shown in FIG. 7C, the pixel PX1 is in a state of, for example, a theoretical 15^{th} gradation and the pixel PX2 is in a state of, for example, a theoretical 13^{th} gradation. In addition, the 15^{th} gradation and the 13^{th} gradation here are for conveniently showing the degree of the state to which the white particles 82 are drawn to the common electrode 22 side as already described and differ as a display state from the 0^{th} gradation to the 11^{th} gradation. Both the pixel PX1 in the state of the 15^{th} gradation and the pixel PX2 in the state of the 13^{th} gradation display white (that is, the 11^{th} gradation).

Next, in FIG. 6, excessive black preparation driving is performed (step ST40). That is, by supplying negative polarity voltage pulses to the pixels 20 which are to display the 0^{th} gradation and the pixels 20 which are to display the 1^{st} gradation out of the plurality of pixels 20 in the display unit 3, Coulomb force toward the common electrode 22 side (that is, display surface side) is added to the black particles 83 and Coulomb force toward the pixel electrode 21 side is added to the white particles 82. In the example in FIG. 5, out of the plurality of pixels 20 in the display unit 3, the pixel PX12 which is to display the 0^{th} gradation is supplied with a negative polarity voltage pulse P12 (refer to FIG. 11 described later), and the pixel PX11 which is to display the 1^{st} gradation is supplied with a negative polarity voltage pulse P11 (refer to FIG. 11 described later). In addition, the pixel PX12 is an example of the “third pixel” according to the invention, and the pixel PX11 is an example of the “fourth pixel” according to the invention. The voltage pulse P12 is an example of the “fourth voltage pulse” according to the invention, and the voltage pulse P11 is an example of the “sixth voltage pulse” according to the invention.

As such, in the pixel PX11 and pixel PX12, there is a state where Coulomb force toward the common electrode 22 side is added to the black particles 83 for a longer period of time and Coulomb force toward the pixel electrode 21 side is added to the white particles 82 for a longer period of time compared to pixels PX7 to pixels PX10. In other words, in the pixel PX11 and pixel PX12, there is a state where the black particles 83 are largely biased toward the common electrode 22 side and the white particles 82 are largely biased toward the pixel electrode 21 side compared to pixel PX7 to pixel PX10.

Normally, since the 0^{th} gradation is the blackest display state, the display state of the pixel PX11 and the display state of the pixel PX12 are difficult to distinguish from the display state of the pixel PX7 to the display state of the pixel PX10. However, in the description below, for convenience, as shown in FIG. 7D, each of the display state of the pixel PX11 and the display state of the pixel PX12 are appropriately described as a theoretical gradation lower than the 0^{th} gradation corresponding to a duration of the negative polarity voltage pulse applied in excessive black preparation driving (step ST40).

In the embodiment, a duration T12 of the negative polarity voltage pulse P12 supplied to the pixel PX12 which is to display the 0^{th} gradation is longer than a duration T11 of the negative polarity voltage pulse P11 supplied to the pixel PX11 which is to display the 1^{st} gradation. As such, for convenience, as shown in FIG. 7D, the pixel PX12 is in a state of, for example, a theoretical −4^{th} gradation and the pixel PX11 is in a state of, for example, a theoretical −2^{nd} gradation. In addition, the −4^{th} gradation and the −2^{nd} gradation here are for conveniently showing the degree of the state to which the black particles 83 are drawn to the common electrode 22 side as already described and differ as a display state from the 0^{th} gradation to the 11^{th} gradation. Both the pixel PX12 in the state of the −4^{th} gradation and the pixel PX11 in the state of the −2^{nd} gradation display black (that is, the 0^{th} gradation).

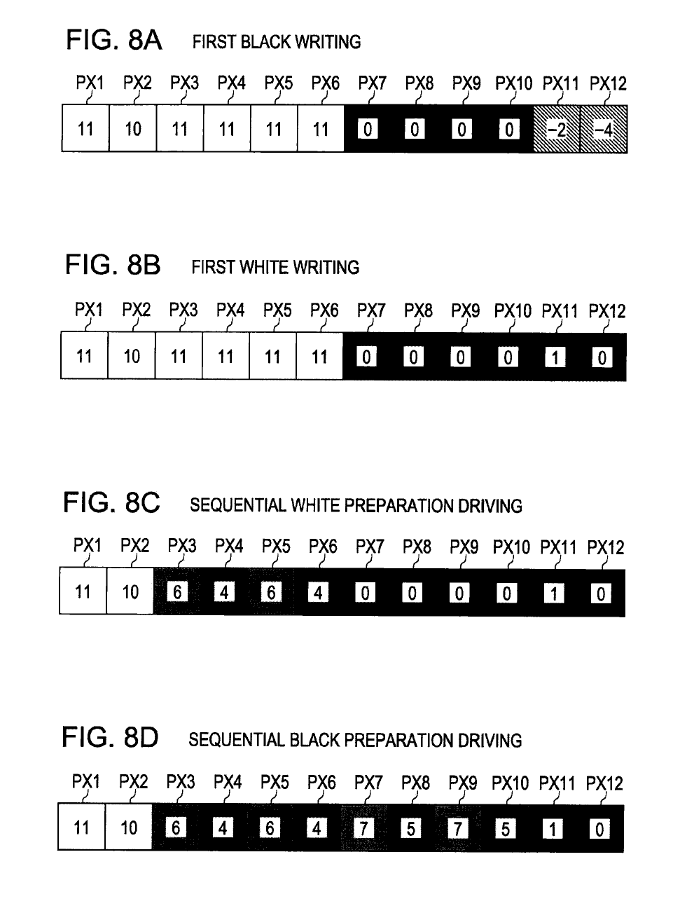

Next, in FIG. 6, first black writing is performed (step ST50). That is, out of the plurality of pixels 20 in the display unit 3, the pixels 20, which are set to a state of a gradation higher than the gradation to be displayed by the excessive white preparation driving (step ST30), are supplied with a negative polarity voltage pulse. In the example in FIG. 5, out of the plurality of pixels 20 in the display unit 3, the pixel PX1 and the pixel PX2 where the excessive white preparation driving has been performed (step ST30) are supplied with a negative polarity voltage pulse Pb1 (refer to FIG. 10 described later). In addition, the voltage pulse Pb1 is an example of the “second voltage pulse” according to the invention. According to this, as shown in FIG. 8A, it is possible for the pixel PX1 to display the 11^{th} gradation (that is, white) and for the pixel PX2 to display the 10^{th} gradation. That is, it is possible for the pixel PX1 and the pixel PX2 to display the gradation to be displayed.

Next, in FIG. 6, first white writing is performed (step ST60). That is, out of the plurality of pixels 20 in the display unit 3, the pixels 20, which are set to a state of a gradation lower than the gradation to be displayed by the excessive black preparation driving (step ST40), are supplied with a positive polarity voltage pulse. In the example in FIG. 5, out of the plurality of pixels 20 in the display unit 3, the pixel PX12 and the pixel PX11 where the excessive black preparation driving (step ST40) has been performed are supplied with a positive polarity voltage pulse Pw1 (refer to FIG. 11 described later). In addition, the voltage pulse Pw1 is an example of the “fifth voltage pulse” according to the invention. According to this, as shown in FIG. 8B, it is possible for the pixel PX12 to display the 0^{th} gradation (that is, black) and for the pixel PX11 to display the 1^{st} gradation. That is, it is possible for the pixel PX12 and the pixel PX11 to display the gradation to be displayed.

Next, in FIG. 6, sequential black preparation driving is performed (step ST70). That is, out of the plurality of pixels 20 in the display unit 3, the pixels 20 which are to display the 9^{th} gradation, the pixels 20 which are to display the 8^{th} gradation, the pixels 20 which are to display the 7^{th} gradation and the pixels 20 which are to display the 6^{th} gradation are supplied with a negative polarity voltage pulse. Thus, the black particles 83 are moved to the common electrode 22 side (that is, display surface side) and the white particles 82 are moved to the pixel electrode 21 side.

In the example of FIG. 5, out of the plurality of pixels 20 in the display unit 3, the pixel PX3 which is to display the 9^{th} gradation and the pixel PX5 which is to display the 7^{th} gradation are supplied with a negative polarity voltage pulse P3 (refer to FIG. 10 described later), and the pixel PX4 which is to display the 8^{th} gradation and the pixel PX6 which is to display the 6^{th} gradation are supplied with a negative polarity voltage pulse P4 (refer to FIG. 10 described later). The pixel PX3 and the pixel PX5 are examples of the “first pixel” according to the invention, and the pixel PX4 and the pixel PX6 are examples of the “second pixel” according to the invention. The voltage pulse P3 is an example of the “first voltage pulse” according to the invention, and the voltage pulse P4 is an example of the “third voltage pulse” according to the invention. In the embodiment, a duration T4 of the negative polarity voltage pulse P4, which is supplied to the pixel PX4 which is to display the 8^{th} gradation and the pixel PX6 which is to display the 6^{th} gradation, is longer than a duration T3 of the negative polarity voltage pulse P3, which is supplied to the pixel PX3 which is to display the 9^{th} gradation and the pixel PX5 which is to display the 7^{th} gradation. As such the pixel PX4 and the pixel PX6 become a display state closer to black (that is, the 0^{th} gradation) than the pixel PX3 and the pixel PX5. Accordingly, as shown in FIG. 8C, the pixel PX3 and the pixel PX5 display, for example, the 6^{th} gradation and the pixel PX4 and the pixel PX6 display, for example, the 4^{th} gradation.

Next, in FIG. 6, sequential white preparation driving is performed (step ST80). That is, out of the plurality of pixels 20 in the display unit 3, the pixels 20 which are to display the 5^{th} gradation, the pixels 20 which are to display the 4^{th} gradation, the pixels 20 which are to display the 3^{rd} gradation and the pixels 20 which are to display the 2^{nd} gradation are supplied with a positive polarity voltage pulse. Thus, the white particles 82 are moved to the common electrode 22 side (that is, display surface side) and the black particles 83 are moved to the pixel electrode 21 side.

In the example of FIG. 5, out of the plurality of pixels 20 in the display unit 3, the pixel PX10 which is to display the 2^{nd} gradation and the pixel PX8 which is to display the 4^{th} gradation are supplied with a positive polarity voltage pulse P10 (refer to FIG. 11 described later), and the pixel PX9 which is to display the 3^{th} gradation and the pixel PX7 which is to display the 5^{th} gradation are supplied with a positive polarity voltage pulse P9 (refer to FIG. 11 described later). In addition, the pixel PX10 and the pixel PX8 are examples of the “first pixel” according to the invention, and the pixel PX9 and the pixel PX7 are examples of the “second pixel” according to the invention. The voltage pulse P10 is an example of the “fourth voltage pulse” according to the invention, and the voltage pulse P9 is an example of the “sixth voltage pulse” according to the invention. In the embodiment, a duration T9 of the positive polarity voltage pulse P9, which is supplied to the pixel PX9 which is to display the 3^{rd} gradation and the pixel PX7 which is to display the 5^{th} gradation, is longer than a duration T10 of the positive polarity voltage pulse P10, which is supplied to the pixel PX10 which is to display the 2^{nd} gradation and the pixel PX8 which is to display the 4^{th} gradation. As such the pixel PX9 and the pixel PX7 become a display state closer to white (that is, the 11^{th} gradation) than the pixel PX10 and the pixel PX8. Accordingly, as shown in FIG. 8D, the pixel PX10 and the pixel PX8 display, for example, the 5^{th} gradation and the pixel PX9 and the pixel PX7 display, for example, the 7^{th} gradation.

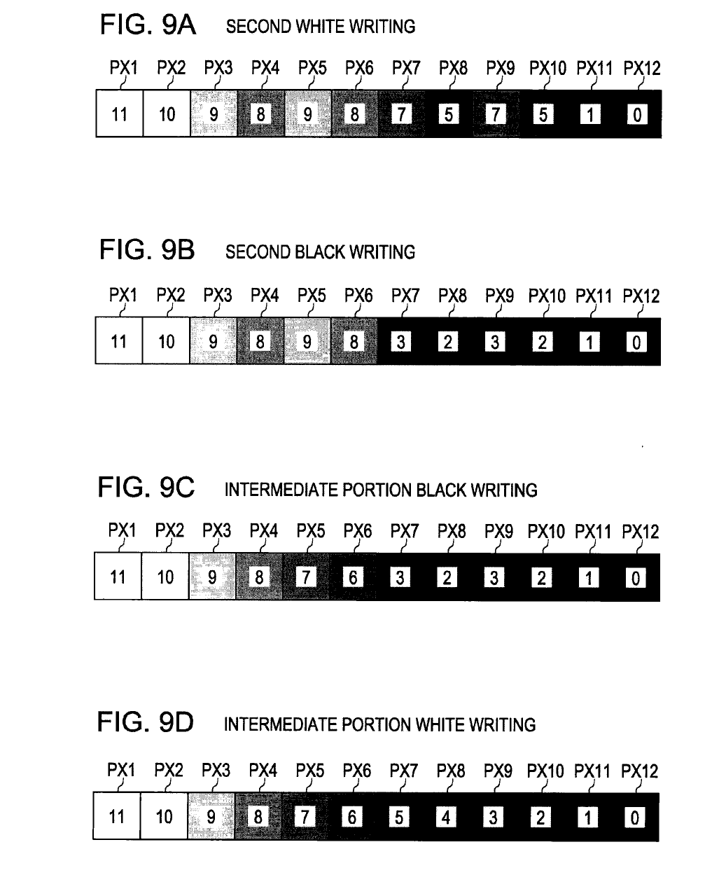

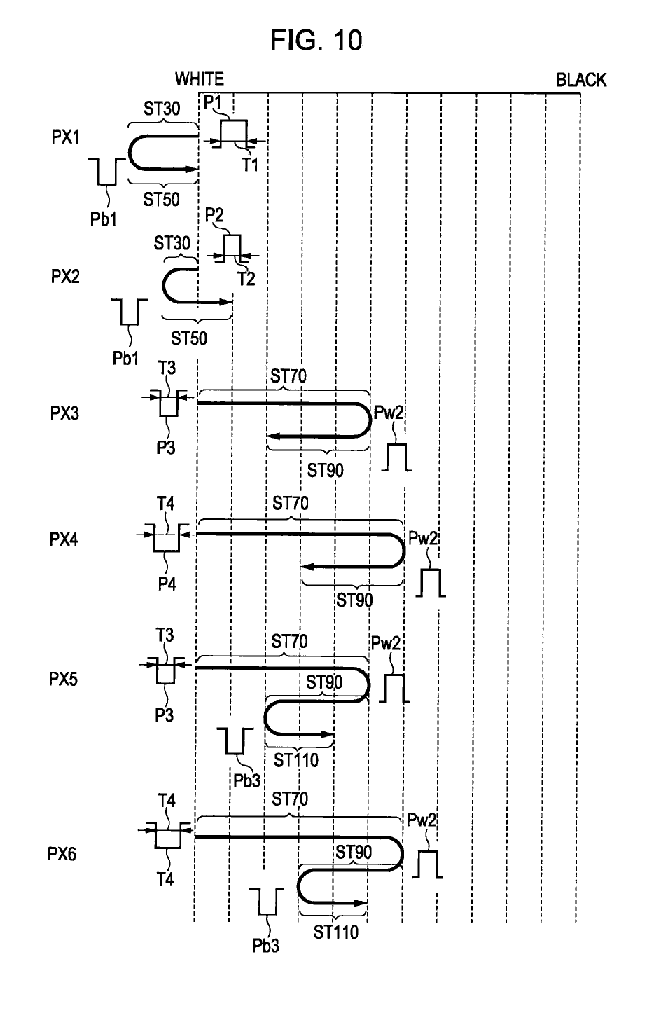

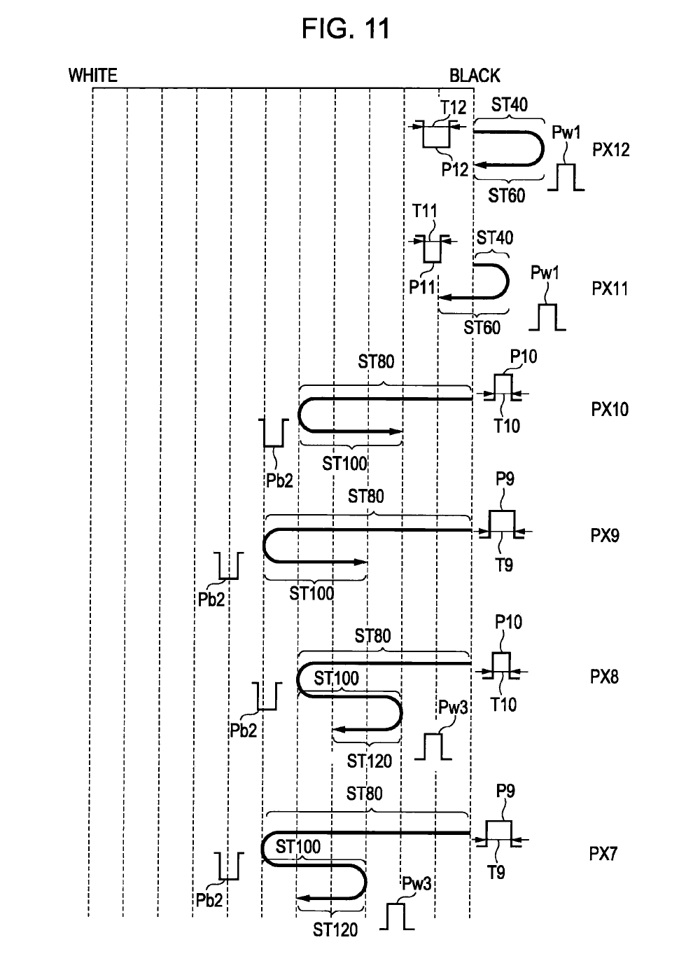

Next, in FIG. 6, second white writing is performed (step ST90). That is, out of the plurality of pixels 20 in the display unit 3, the pixels 20, which are set to a gradation lower than the gradation to be displayed by the sequential black preparation driving (step ST70), are supplied with a positive polarity voltage pulse. In the example in FIG. 5, out of the plurality of pixels 20 in the display unit 3, the pixel PX3 to PX6 where the sequential black preparation driving (step ST70) has been performed are supplied with a positive polarity voltage pulse Pw2 (refer to FIG. 10 described later). In addition, the voltage pulse Pw2 is an example of the “second voltage pulse” according to the invention. According to this, as shown in FIG. 9A, it is possible for the pixel PX3 to display the 9^{th} gradation and for the pixel PX4 to display the 8^{th} gradation. That is, it is possible for the pixel PX3 and the pixel PX4 to display the gradation to be displayed. At this time, the pixel PX5 displays, for example, the 9^{th} gradation and the pixel PX6 displays, for example, the 8^{th} gradation.

Next, in FIG. 6, second black writing is performed (step ST100). That is, out of the plurality of pixels 20 in the display unit 3, the pixels 20, which are set to a gradation higher than the gradation to be displayed by the sequential white preparation driving (step ST80), are supplied with a negative polarity voltage pulse. In the example in FIG. 5, out of the plurality of pixels 20 in the display unit 3, the pixel PX7 to PX10 where the sequential white preparation driving has been performed (step ST80) are supplied with a negative polarity voltage pulse Pb2 (refer to FIG. 11 described later). In addition, the voltage pulse Pb2 is an example of the “fifth voltage pulse” according to the invention. According to this, as shown in FIG. 9B, it is possible for the pixel PX10 to display the 2^{nd} gradation and for the pixel PX9 to display the 3^{rd} gradation. That is, it is possible for the pixel PX10 and the pixel PX9 to display the gradation to be displayed. At this time, the pixel PX8 displays, for example, the 2^{nd} gradation and the pixel PX7 displays, for example, the 3^{rd} gradation.

Next, in FIG. 6, intermediate portion black writing is performed (step ST110). That is, out of the plurality of pixels 20 in the display unit 3, the pixels 20, which are set to a gradation higher than the gradation to be displayed by the second white writing (step ST90), are supplied with a negative polarity voltage pulse. In the example in FIG. 5, out of the plurality of pixels 20 in the display unit 3, the pixel PX5 and the pixel PX6, which are set to a gradation higher than the gradation to be displayed by the second white writing (step ST90), are supplied with a negative polarity voltage pulse Pb3 (refer to FIG. 10 described later). In addition, the voltage pulse Pb3 is an example of the “seventh voltage pulse” according to the invention. According to this, as shown in FIG. 9C, it is possible for the pixel PX5 to display the 7^{th} gradation and for the pixel PX6 to display the 6^{th} gradation. That is, it is possible for the pixel PX5 and the pixel PX6 to display the gradation to be displayed.

Next, in FIG. 6, intermediate portion white writing is performed (step ST120). That is, out of the plurality of pixels 20 in the display unit 3, the pixels 20, which are set to a gradation lower than the gradation to be displayed by the second black writing (step ST100), are supplied with a positive polarity voltage pulse. In the example in FIG. 5, out of the plurality of pixels 20 in the display unit 3, the pixel PX8 and the pixel PX7, which are set to a gradation lower than the gradation to be displayed by the second black writing (step ST100), are supplied with a positive polarity voltage pulse Pw3 (refer to FIG. 11 described later). In addition, the voltage pulse Pw3 is an example of the “eighth voltage pulse” according to the invention. According to this, as shown in FIG. 9D, it is possible for the pixel PX8 to display the 4^{th} gradation and for the pixel PX7 to display the 5^{th} gradation. That is, it is possible for the pixel PX8 and the pixel PX7 to display the gradation to be displayed.

As described above, according to the embodiment, it is possible to display an image with 12 gradations as shown in FIG. 5 for example by performing the steps ST10 to ST120 described above with reference to FIG. 6.

Next, description of the driving method of the electrophoretic display device according to the embodiment will be added with reference to FIGS. 10 and 11.

FIGS. 10 and 11 are conceptual diagrams for describing the driving method of the electrophoretic display device according to the embodiment. In addition, FIG. 10 conceptually shows the voltage pulses supplied in each step described above with reference to FIG. 6 and changes in the display states of the pixels when the voltage pulses are supplied, with regard to the pixel PX1 to the pixel PX6 shown in FIG. 5. FIG. 11 conceptually shows the voltage pulses supplied in each step described above with reference to FIG. 6 and changes in the display states of the pixels when the voltage pulses are supplied, with regard to the pixel PX7 to the pixel PX12 shown in FIG. 5. Additionally, the horizontal axis in FIGS. 10 and 11 shows the gradation which is the display state of the pixel (in other words, the density of the color displayed in the pixel).

In FIG. 10, according to the driving method of the embodiment, by supplying the positive polarity voltage pulse P1 to the pixel PX1 which displays white (that is, the 11^{th} gradation) in the excessive white preparation driving (step ST30), the pixel PX1 is set to a state (for example, the 15^{th} gradation state) where the white particles 82 are drawn more to the common electrode 22 side than the 11^{th} gradation. Additionally, by supplying the positive polarity voltage pulse P2 to the pixel PX2 which displays white (that is, the 11^{th} gradation) in the excessive white preparation driving (step ST30), the pixel PX2 is set to a state (for example, the 13^{th} gradation state) where the white particles 82 are drawn to the common electrode 22 side more than the 11^{th} gradation. Here, in the embodiment, the duration T1 of the voltage pulse P1 is set to be longer than the duration T2 of the voltage pulse P2, and the pixel PX1 enters a state where the white particles 82 are drawn to the common electrode 22 side more than the pixel PX2.

In this manner, the negative polarity voltage pulse Pb1 is supplied in the first black writing (step ST50) to the pixel PX1 and the pixel PX2 where the excessive white preparation driving (step ST30) has been performed. According to this, it is possible for the pixel PX1 to display the 11^{th} gradation (that is, white) and the pixel PX2 to display the 10^{th} gradation.

Here, in the embodiment, in particular, the negative polarity voltage pulse Pb1 is supplied in the first black writing (step ST50) to the pixel PX1 and the pixel PX2 which are in different display states from each other due to the supplying of either voltage pulse of the positive polarity voltage pulse P1 or the positive polarity voltage pulse P2 in the excessive white preparation driving (step ST30). According to this, it is possible to reduce the difference in the display state of the pixel PX1 and the display state of the pixel PX2. In other words, it is possible to finely control the difference in the gradation between the pixel PX1 and the pixel PX2. That is, for example, it is possible to express a finer gradation using the pixel PX1 and the pixel PX2 compared to a case where a gradation displayed in the pixels PX1 and PX2 is controlled by not supplying a voltage pulse to the pixel PX1 which displays white (that is, the 11^{th} gradation) and supplying only a negative polarity voltage pulse to the pixel PX2 which displays white (that is, the 11^{th} gradation).

On the other hand, in FIG. 11, according to the driving method of the embodiment, by supplying the negative polarity voltage pulse P12 to the pixel PX12 which displays black (that is, the 0^{th} gradation) in the excessive black preparation driving (step ST40), the pixel PX12 is set to a state (for example, the −4^{th} gradation state) where the black particles 83 are drawn to the common electrode 22 side more than the 0^{th} gradation. Additionally, by supplying the negative polarity voltage pulse P11 to the pixel PX11 which displays black (that is, the 0^{th} gradation) in the excessive black preparation driving (step ST40), the pixel PX11 is set to a state (for example, the −2^{nd} gradation state) where the black particles 83 are drawn to the common electrode 22 side more than the 0^{th} gradation. Here, in the embodiment, the duration T12 of the voltage pulse P12 is set to be longer than the duration T11 of the voltage pulse P11, and the pixel PX12 enters a state where the black particles 83 are drawn to the common electrode 22 side more than the pixel PX11.

In this manner, the positive polarity voltage pulse Pw1 is supplied in the first white writing (step ST60) to the pixel PX12 and the pixel PX11 where the excessive black preparation driving (step ST40) has been performed. According to this, it is possible for the pixel PX12 to display the 0^{th} gradation (that is, black) and the pixel PX11 to display the 1^{st} gradation.

Next, in FIG. 10, according to the driving method of the embodiment, by supplying the negative polarity voltage pulse P3 to the pixel PX3 which displays white (that is, the 11^{th} gradation) in the sequential black preparation driving (step ST70), the pixel PX3 is set to a gradation (for example, the 6^{th} gradation) lower than the gradation to be displayed (that is, the 9^{th} gradation in FIG. 5). Additionally, by supplying the negative polarity voltage pulse P4, which has the duration T4 longer than the duration T3 of the voltage pulse P3, to the pixel PX4 which displays white (that is, the 11^{th} gradation) in the sequential black preparation driving (step ST70), the pixel PX4 is set to a gradation (for example, the 4^{th} gradation) lower than the gradation to be displayed (that is, the 8^{th} gradation in FIG. 5).

In this manner, the positive polarity voltage pulse Pw2 is supplied in the second white writing (step ST90) to the pixel PX3 and the pixel PX4 where the sequential black preparation driving (step ST70) has been performed. According to this, it is possible for the pixel PX3 to display the 9^{th} gradation and the pixel PX4 to display the 8^{th} gradation.

Here, in the embodiment, in particular, the positive polarity voltage pulse Pw2 is supplied in the second white writing (step ST90) to the pixel PX3 and the pixel PX4 which are in different display states from each other due to the supplying of the negative polarity voltage pulses P3 and P4 in the sequential black preparation driving (step ST70). According to this, it is possible to reduce a difference in the display state of the pixel PX3 and the display state of the pixel PX4. In other words, it is possible to finely control the difference in the gradation between the pixel PX3 and the pixel PX4. That is, for example, it is possible to express a finer gradation using the pixel PX3 and the pixel PX4 compared to a case where a gradation displayed in the pixels PX3 and PX4 is controlled by supplying only a negative polarity voltage pulse to the pixel PX3 which displays white (that is, the 11^{th} gradation) and supplying only a negative polarity voltage pulse, where the duration is different to the negative polarity voltage pulse supplied to the pixel PX3, to the pixel PX4 which displays white (that is, the 11^{th} gradation).

On the other hand, in FIG. 11, according to the driving method of the embodiment, by supplying the positive polarity voltage pulse P10 to the pixel PX10 which displays black (that is, the 0^{th} gradation) in the sequential white preparation driving (step ST80), the pixel PX10 is set to a gradation (for example, the 5^{th} gradation) higher than the gradation to be displayed (that is, the 2^{nd} gradation in FIG. 5). Additionally, by supplying the positive polarity voltage pulse P9, which has the duration T9 longer than the duration T10 of the voltage pulse P10, to the pixel PX9 which displays black (that is, the 0^{th} gradation) in the sequential white preparation driving (step ST80), the pixel PX9 is set to a gradation (for example, the 7^{th} gradation) higher than the gradation to be displayed (that is, the 3^{rd} gradation in FIG. 5).

In this manner, the negative polarity voltage pulse Pb2 is supplied in the second black writing (step ST100) to the pixel PX10 and the pixel PX9 where the sequential white preparation driving (step ST80) has been performed. According to this, it is possible for the pixel PX10 to display the 2^{nd} gradation and the pixel PX9 to display the 3^{rd} gradation.

In FIG. 10, according to the driving method of the embodiment, by supplying the negative polarity voltage pulse P3 to the pixel PX5 which displays white (that is, the 11^{th} gradation) in the sequential black preparation driving (step ST70), the pixel PX5 is set to a gradation (for example, the 6^{th} gradation) lower than the gradation to be displayed (that is, the 7^{th} gradation in FIG. 5). Additionally, by supplying the negative polarity voltage pulse P4, which has the duration T4 longer than the duration T3 of the voltage pulse P3, to the pixel PX6 which displays white (that is, the 11^{th} gradation) in the sequential black preparation driving (step ST70), the pixel PX6 is set to a gradation (for example, the 4th gradation) lower than the gradation to be displayed (that is, the 6^{th} gradation in FIG. 5).

In this manner, after the positive polarity voltage pulse Pw2 is supplied in the second white writing (step ST90) to the pixel PX5 and PX6 where the sequential black preparation driving (step ST70) has been performed, the negative polarity voltage pulse Pb3 is further supplied in the intermediate portion black writing (step ST110). According to this, it is possible for the pixel PX5 to display the 7^{th} gradation and the pixel PX6 to display the 6^{th} gradation.

Here, in the embodiment, in particular, after the positive polarity voltage pulse Pw2 is supplied in the second white writing (step ST90) to the pixel PX5 and PX6 which are in different display states from each other due to the supplying of the negative polarity voltage pulses P3 and P4 in the sequential black preparation driving (step ST70), the negative polarity voltage pulse Pb3 is further supplied in the intermediate portion black writing (step ST110). According to this, it is possible to reduce a difference in the display state of the pixel PX5 and the display state of the pixel PX6. In other words, it is possible to finely control the difference in the gradation between the pixel PX5 and the pixel PX6. That is, for example, it is possible to express a finer gradation using the pixel PX5 and the pixel PX6 compared to a case where a gradation displayed in the pixel PX5 and PX6 is controlled by supplying only a negative polarity voltage pulse to the pixel PX5 which displays white (that is, the 11^{th} gradation) and supplying only a negative polarity voltage pulse, where the duration is different to the negative polarity voltage pulse supplied to the pixel PX5, to the pixel PX6 which displays white (that is, the 11^{th} gradation).

On the other hand, in FIG. 11, according to the driving method of the embodiment, by supplying the positive polarity voltage pulse P10 to the pixel PX8 which displays black (that is, the 0^{th} gradation) in the sequential white preparation driving (step ST80), the pixel PX8 is set to a gradation (for example, the 5^{th} gradation) higher than the gradation to be displayed (that is, the 4^{th} gradation in the example in FIG. 5). Additionally, by supplying the positive polarity voltage pulse P9, which has the duration T9 longer than the duration T10 of the voltage pulse P10, to the pixel PX7 which displays black (that is, the 0^{th} gradation) in the sequential white preparation driving (step ST80), the pixel PX7 is set to a gradation (for example, the 7^{th} gradation) higher than the gradation to be displayed (that is, the 5^{th} gradation in the example in FIG. 5).

In this manner, after the negative polarity voltage pulse Pb2 is supplied in the second black writing (step ST100) to the pixel PX8 and PX7 where the sequential white preparation driving (step ST80) has been performed, the positive polarity voltage pulse Pw3 is further supplied in the intermediate portion white writing (step ST120). According to this, it is possible for the pixel PX8 to display the 4^{th} gradation and the pixel PX7 to display the 5^{th} gradation.

As described above, according to the driving method of the electrophoretic display device of the embodiment, it is possible to perform multitone display with high precision.

The invention is not limited to the embodiment described above, and various modifications can be made within the spirit and the concept of the invention as stated in the scope of the claims, and a driving method of an electrophoretic display device according to the modifications is included in the technical scope of the invention.

The entire disclosure of Japanese Patent Application No. 2010-046904, filed Mar. 3, 2010 is expressly incorporated by reference herein.

What is claimed is:

1. A driving method of an electrophoretic display device, which has a plurality of pixels where an electrophoretic layer is interposed between a first electrode and a second electrode, and when in a case when the potential of the first electrode is higher than the potential of the second electrode, a potential difference generated between the first electrode and the second electrode is set to a first polarity, and in a case when the potential of the first electrode is lower than the potential of the second electrode, a potential difference generated between the first electrode and the second electrode is set to a second polarity, as a display state of the pixel, a first display state is selected by supplying a voltage with the first polarity to the pixel and a second display state is selected by supplying a voltage with the second polarity to the pixel, and in regard to one pixel in one display state of the first display state and the second display state, a halftone state between the first display state and the second display state is selected according to a total duration of the voltage applied to select the other display state of the first display state and the second display state, comprising:
supplying a first voltage pulse with one polarity of the first polarity and the second polarity to a first pixel in the first display state of the plurality of pixels;
supplying a second voltage pulse with the other polarity of the first polarity and the second polarity to the first pixel;
supplying a third voltage pulse, which has the same polarity as the polarity of the first voltage pulse and has a duration different from a duration of the first voltage pulse, to a second pixel which is in the first display state of the plurality of pixels; and
supplying the second voltage pulse to the second pixel.

2. The driving method of an electrophoretic display device according to claim 1, further comprising:
supplying a fourth voltage pulse with one polarity of the first polarity and the second polarity to a third pixel in the second display state of the plurality of pixels;
supplying a fifth voltage pulse with the other polarity of the first polarity and the second polarity to the third pixel;
supplying a sixth voltage pulse, which has the same polarity as the polarity of the fourth voltage pulse and has a duration different from a duration of the fourth voltage pulse, to a fourth pixel which is in the second display state of the plurality of pixels; and
supplying the fifth voltage pulse to the fourth pixel.

3. The driving method of an electrophoretic display device according to claim 1, further comprising:
supplying a seventh voltage pulse with a polarity different from the second voltage pulse to the first pixel and the second pixel.

4. The driving method of an electrophoretic display device according to claim 1, further comprising:
supplying an eighth voltage pulse with a polarity different from the fifth voltage pulse to the third pixel and the fourth pixel.

5. A controller for controlling an electrophoretic display device, which has a plurality of pixels where an electrophoretic layer is interposed between a first electrode and a second electrode, and when in a case when the potential of the first electrode is higher than the potential of the second electrode, a potential difference generated between the first electrode and the second electrode is set to a first polarity, and in a case when the potential of the first electrode is lower than the potential of the second electrode, a potential difference generated between the first electrode and the second electrode is set to a second polarity, as a display state of the pixel, a first display state is selected by supplying a voltage with the first polarity to the pixel and a second display state is selected by supplying a voltage with the second polarity to the pixel, and in regard to one pixel in one display state of the first display state and the second display state, a halftone state between the first display state and the second display state is selected according to a total duration of the voltage applied to select the other display state of the first display state and the second display state, the controller executing a driving method comprising:
supplying a first voltage pulse with one polarity of the first polarity and the second polarity to a first pixel in the first display state of the plurality of pixels;
supplying a second voltage pulse with the other polarity of the first polarity and the second polarity to the first pixel;
supplying a third voltage pulse, which has the same polarity as the polarity of the first voltage pulse and has a duration different from a duration of the first voltage pulse, to a second pixel which is in the first display state of the plurality of pixels; and
supplying the second voltage pulse to the second pixel.

6. The controller according to claim 5, the driving method further comprising:
supplying a fourth voltage pulse with one polarity of the first polarity and the second polarity to a third pixel in the second display state of the plurality of pixels;
supplying a fifth voltage pulse with the other polarity of the first polarity and the second polarity to the third pixel;
supplying a sixth voltage pulse, which has the same polarity as the polarity of the fourth voltage pulse and has a duration different from a duration of the fourth voltage pulse, to a fourth pixel which is in the second display state of the plurality of pixels; and
supplying the fifth voltage pulse to the fourth pixel.

7. The controller according to claim 5, the driving method further comprising:
supplying a seventh voltage pulse with a polarity different from the second voltage pulse to the first pixel and the second pixel.

8. The controller according to claim 5, the driving method further comprising:
supplying an eighth voltage pulse with a polarity different from the fifth voltage pulse to the third pixel and the fourth pixel.
